(19) United States
(12) Patent Application Publication
(10) Pub. No.: US 2014/0006021 A1
(43) Pub. Date: Jan. 2, 2014

(54) METHOD FOR ADJUSTING DISCRETE MODEL COMPLEXITY IN AN AUTOMATIC SPEECH RECOGNITION SYSTEM

(71) Applicant: Marcin Kuropatwinski, Gdansk (PL)

(72) Inventor: Marcin Kuropatwinski, Gdansk (PL)

(73) Assignee: VOICE LAB SP. Z O.O., Gdynia (PL)

(21) Appl. No.: 13/567,963

(22) Filed: Aug. 6, 2012

(30) Foreign Application Priority Data
Jun. 27, 2012 (PL) P-399698

(51) Int. Cl. G10L 15/26

(52) U.S. Cl. 704/235; 704/E15.043

(57) ABSTRACT

Systems and methods for adjusting a discrete acoustic model complexity in an automatic speech recognition system. In some cases, the systems and methods include a discrete acoustic model, a pronunciation dictionary, and optionally a language model or a grammar model. In some cases, the methods include providing a speech database comprising multiple pairs, each pair including a speech recording called a waveform and an orthographic transcription of the waveform; constructing the discrete acoustic model by converting the orthographic transcription into a phonetic transcription; parameterizing the speech database by transforming the waveforms into a sequence of feature vectors and normalizing the sequences of the feature vectors; and training the acoustic model with the normalized sequences of the feature vectors, wherein the complexity PI of the discrete acoustic model is further adjusted through a procedure that uses a given generalization coefficient N. Other implementations are described.

### FIELD OF THE INVENTION

The invention relates to automatic speech recognition systems. More precisely, the invention relates to a method for adjusting a discrete acoustic model complexity in an automatic speech recognition system, comprising said discrete acoustic model, pronunciation dictionary and optionally a language model or a grammar.

### BACKGROUND OF THE INVENTION

Automatic speech recognition (ASR) systems are widely used in different technical fields. The ASR systems can enrich user-machine communication through providing convenient interface, which allows for speaking of commands, dictation of texts and filling of forms by voice. A possible application of ASR could be also in telecommunication for voice dialing or for enabling a voice activated virtual agents supporting customers calling the call centers for help. It is important for such system to achieve best possible performance and optimal operation time.

In a speech recognition system a number of knowledge sources about the speech and language are used simultaneously to find accurate transcriptions of the spoken utterances. This idea is illustrated in the FIG. 1. Operation of the recognition module is based on Hidden Markov Models and dynamic programming—in most of the contemporary systems. For reference on these methods see [1].

### BRIEF SUMMARY OF THE INVENTION

The proposed invention is concerned with finding the acoustic model based on training data.

In particular the invention considers the discrete acoustic models known from the literature. A new method of obtaining the optimal complexity (to be defined latter) discrete model is proposed. The acoustic model obtained using proposed method is optimal with respect to both, accuracy and generalization. Thus the proposed method solves in an optimal manner the accuracy/generalization tradeoff. The proposed method is a part of larger set of methods, which transform the speech database into an acoustic model, see FIG. 2.

This transformation will be described in details in the following Sections.

### Preliminary Processing of the Speech Database

Typically, the acoustic models, needed by the speech recognizer, are obtained through a multistage processing of pairs containing speech waveforms and their orthographic transcripts. In preparation for the proposed training method—including the complexity adjusting procedures, the following processing stages are necessary:
1. Building a speech database:
Each speech recording (acoustic transcript, a.k.a. waveforms) is accompanied by an orthographic transcript. In a system a large number of such pairs (acoustic transcript, orthographic transcript) are involved and each acoustic transcript can contain a few seconds of speech.
2. Parameterization of the speech database:
The waveforms are transformed into sequences of features vectors. The processing of the waveforms is organized temporally in 20-30 ms long frames. The frames advance by a step of 10 ms. Typical features are the Mel Frequency Cepstral Coefficients (MFCC) with delta and delta-delta derivatives. How to obtain the MFCC's is described for example in the HTK Book [2].
3. Normalization of the sequence of the features vectors:
The scatter matrix (correlation matrix of the whole set of features) and the mean vector are computed, and the features are linearly transformed to be zero mean and diagonal, homoscedastic (each variance the same) unit correlation matrix.

The aforementioned steps are required for the subsequent acoustic models training.

### Preparing Input Data for the Model Complexity Adjustment Procedure

The data to be feed into the model complexity adjustment procedure can be acquired, for example, through a web interface. Such a web application allows for registration of persons recording the speech. After registration the process of recording speech is started. The person reads the prompts shown on the top of the page and, after each prompt, the speech recording is transferred to our server together with the orthographic transcription of the recorded utterance and the person is asked to record another prompt.

Thus the database contains pairs of orthographic transcriptions and speech waveforms, see FIG. 3. The waveforms are typically sampled at 16 kHz and quantized with 16 bit resolution per sample.

The orthographic transcriptions are transformed to phonetic transcription using a trainable grapheme to phoneme converter like, e.g., the sequitur g2p tool [3], or rule-based systems.

### Computation and Normalization of Features

The waveforms are transformed into sequences of features vectors. The processing of the waveforms is organized temporally in 20-30 ms long frames. The frames advance by a step of 10 ms. Typical features are the Mel Frequency Cepstral Coefficients (MFCC) with delta and delta-delta derivatives. MFCC's are described for example in the HTK Book [2]. We denote the sequences of features vectors as Yᵢ={f_{i,j}}, iε{1, . . . , G}, jε{1, . . . , Oᵢ} where G is the number of waveform/transcription pairs and Oᵢ is the number of frames in the i-th waveform. Each features vector is a member of the Euclidean space f_{i,j}ε [symbol] ^{p}. Typically, the features dimension p is equal 39 for the MFCCs.

The next step in processing features is to decorrelate them. Toward this the scatter matrix Sε [symbol] ^{p×p} is computed according to:

$$m = {\sum }_{i} {\sum }_{j} {f}_{i , j} \\ S = {\sum }_{i} {\sum }_{j} ( {f}_{i , j} - m ) {( {f}_{i , j} - m )}^{T} = {R}^{T} R , \qquad ( 1 ) , ( 2 )$$

where R is the Cholesky factor [4] of the scatter matrix.

Given the scatter matrix and the mean vector the features are decorrelated according to the prescription:

d_{i,j}=(f_{i,j}−m)R⁻¹. (3)

After the above procedure we have a set of decorrelated features, which are zero mean and with the correlation matrix normalized to the identity matrix. The features vector d_{i,j}=[a_{i,j}^{T},Δ_{i,j}^{T},ΔΔ_{i,j}^{T}]^{T} consists of the basic MFCC's, a_{i,j}ε [symbol] ¹³, its delta derivatives, Δ_{i,j}ε [symbol] ¹³, and its delta-delta derivatives ΔΔ_{i,j}ε [symbol] ¹³.

According to some embodiments of the invention, the method for adjusting a discrete acoustic model complexity in an automatic speech recognition system comprises a discrete acoustic model, pronunciation dictionary, and optionally a language model or a grammar, said method comprising the steps of:
a. providing a speech database comprising a plurality of pairs, each pair comprising a speech recording called a waveform and an orthographic transcription of the waveform; constructing a discrete acoustic model by converting the orthographic transcription into phonetic transcription; parameterizing the speech database by transforming the waveforms into a sequence of feature vectors; normalizing the sequences of the feature vectors; and training of the acoustic model, which is characterized in that the complexity PI of the discrete acoustic model is adjusted in the following procedure, with a given generalization coefficient N:
a0. Initialization of the PIₘₐₓ such that each quantizer cell contains single training sample and PIₘᵢₙ such that one quantizer cell contains all training samples;
a1. a set of features vectors is taken from the speech database and a quantizer is trained, having complexity of PI=½*(PIₘₐₓ+PIₘᵢₙ);
a2. the training set is quantized with the quantizer obtained in the a1 step;
a3 the training set is segmented into triphones and subphonetic units with the acoustic models implied by the quantizer trained in the a1 step;
a4. if minimum, taken over all triphones and subphonetic units, of M/Z, where M is the number of training samples in a given triphone or subphonetic unit and Z is the number of distinct acoustic symbols belonging to that triphone or subphonetic unit, is less than the assumed generalization coefficient N, the value of PI is taken as the maximal complexity PIₘₐₓ of the discrete acoustic model, and otherwise as the minimal complexity PIₘᵢₙ; and
a5. repeating steps a1-a4 until minimum, taken over all triphones and subphonetic units, of M/Z is equal to assumed generalization coefficient N.

Preferably, the generalization coefficient N of the quantizer is larger than 5, more preferably larger than 10, and most preferably larger than 15.

Preferably, the quantizer in the step a1 is trained using the generalized Lloyd algorithm or the Equitz method.

Preferably, the complexity PI of the quantizer of the discrete acoustic model is defined as the number of codevectors in the trained quantizer.

Preferably, the quantizer in the step a1 is a product quantizer with number of codevectors I distributed among part quantizers.

In another preferred embodiment of the invention, the quantizer in the step a1 is a lattice quantizer.

In such case, preferably, the complexity PI of the quantizer of the discrete acoustic model is defined as the volume of the lattice quantizer cell taken with minus sign.

Preferably, the step a3 is carried out using the Viterbi training.

Preferably, the step a3 is carried out for clustered triphones or tied triphones.

### BRIEF DESCRIPTION OF THE SEVERAL DRAWINGS

The invention will be now described in details with reference to the drawings, in which:

FIG. 1 (prior art) shows a schematic view of a speech recognition system,

FIG. 2 (prior art) illustrates transformation of the speech database (a larger set) into a lightweight acoustic model of much smaller footprint than the speech database alone,

FIG. 3 (prior art) illustrates a transcription/waveform pair,

FIG. 4 (prior art) shows a fragment of the hexagonal lattice,

FIG. 5 (prior art) is an illustration of the difference between a low complexity and a high complexity model,

FIG. 6 shows a plot illustrating the data amounts requirements for learning a given percent of bins in the support, and

FIG. 7 shows a plot illustrating the data amounts requirements for learning a given percent of bins in the support. The less restrictive assumptions are applied as compared to the FIG. 6.

### DETAILED DESCRIPTION OF THE INVENTION

### Proposed Procedure for Adjusting Discrete Model Complexity

Choosing proper model complexity is a much studied topic in machine learning. However, there is no single procedure applicable for wide class of models. Herein we restrict our attention to discrete models, a.k.a. histograms with data dependent partitions. The data dependent partition has both the cells shape and the granularity/resolution/complexity/number of the cells adjustable. The partition under consideration in this patent is derived from vector quantization [5] and it is thus the so called Voronoi partition. The application of the invention is possible if there is a need for a classification based on training data, like e.g. in speakers recognition systems, recognition of faces, graphical signs and other types of data. A short account of vector quantization follows.

### Vector Quantization

Our procedures for adjusting model complexity assumes the features are quantized [5]. There are several issues related to quantization of the features. One have to choose between lattice [6] and trained quantizers [7], between one-stage and product quantizers [5] etc. Next, the quantizer resolution has to be decided upon. The quantizer resolution is given in case of lattice quantizers by volume of the cell and in case of trained quantizers by the number of codevectors in the codebook. Since the features belong to the Euclidean space of dimension p we talk here always of vector quantizers.

Vector quantizer can be viewed as a mapping from p dimensional Euclidean space [symbol] ^{p} onto a discrete set Y⊂ [symbol] ^{p}, Q: [symbol] ^{p}→Y where Y={y₁, . . . , y_{I}}. Set Y is called codebook. Elements of the codebook are the reproduction vectors or codevectors. Vector quantizer tills the space into I sets known as quantizer bins or cells:

$${R}_{1} , {R}_{2} , … , {R}_{I} {{⋃}_{i = 1}}^{I} {R}_{i} = {ℜ}^{p} \qquad ( 4 )$$

defined as Rᵢ=Q⁻¹(yᵢ)={xε [symbol] ^{p}:Q(x)=yᵢ}. The sets Rᵢ have a following property:

Rᵢ∩Rⱼ=Ø for j≠i (5)

It can be shown that the reproduction vector inside the partition element Rᵢ is optimal if it is a center of weight for that partition element. Formally:

$${y}_{i} = \frac{{\int }_{{R}_{i}} xp ( x ) d x}{{\int }_{{R}_{i}} p ( x ) d x} , \qquad ( 6 )$$

where p(x) is the source distribution. Once the source distribution is available implicitly by the training set, the ensemble averages are replaced by sample averages to compute actual placement of the reproduction vectors.

The input vectors to the quantizer are assigned reproduction vectors according to the nearest neighbor rule. It can be shown that the nearest neighbor rule is optimal, minimizing distortion induced by the quantization. Formally the nearest neighbor rule states:

Rᵢ={x:∥x−yᵢ∥≦∥x−yⱼ∥,i#j}, (7)

with any appropriate breaking of ties. Partition defined according to (7) is called the Voronoi partition.

Quantizer with bins (countable but infinite number of them), which are all the same and divide the whole space are known as lattice quantizers. The lattice quantizer, or more precisely the set of reproduction vectors, is defined as follows:

λ={y:y=u^{T}M,uεZ^{p}}, (8)

where M is the so called generator matrix. Volume of the lattice quantizer bin is given by:

det(M) (9)

Lattice quantizers do not require training but constructing them is a difficult mathematical task [8].

A fragment from a hexagonal lattice covering the whole plane is shown in FIG. 4.

A different class of the quantizers is trained quantizers. There is a number of algorithms for obtaining a trained quantizer. To name a few, we have, the generalized Lloyd algorithm (GLA) [5], or a method by Equitz [7], which requires less computations than the Lloyd algorithm at the price of being less accurate (this loss of accuracy is negligible in most practical applications). An often applied workaround, which is aimed at lowering complexity of training and encoding is dividing the space Ω of dimension dim(Ω)=p into subspaces Ω=Ω₁×Ω₂ such that dim(Ω)=dim(Ω₁)+dim(Ω₂). Such quantizers are referred as product quantizers to.

### State-of-the-Art in Choosing Parameters of a Discrete Model

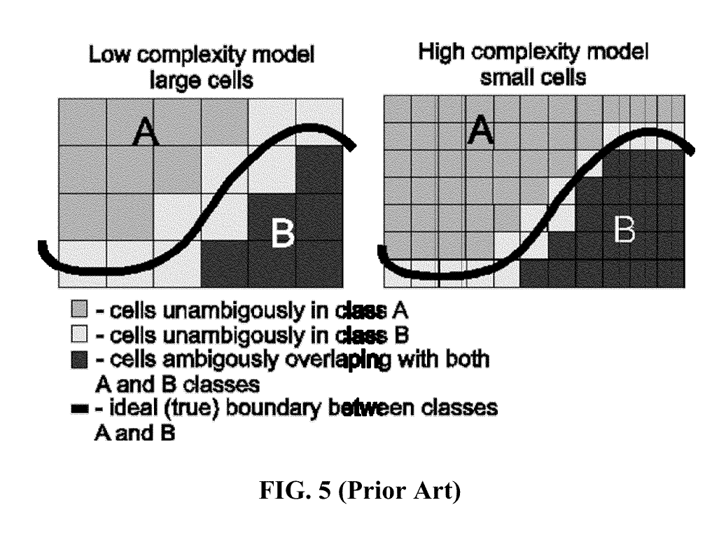

Current practice regarding adjusting discrete model complexity is limited to a simple advice of using a codebook with e.g. 256 entries—this value is typically found in a number of sources dealing with speech recognition with the discrete models, cf. [9], [10]. This rather restrictive setting leaves no room for accurate modeling of phonetic densities especially if there are very large training sets available. The difference between a greedy (low complexity) model and an accurate (high complexity) model is illustrated in the FIG. 5.

Obviously the high complexity model from the FIG. 5 requires more data to be trained reliably. However, the statement ‘more data’ is non-precise—there is no rule to set the partition optimally having the training set fixed. It would be also important to know, having a partition and an initial training set, what additional amount of training data is needed to have a proper model, regarding both accuracy and generalization. Other questions of that kind are, having an initial sample how to obtain the total, approximate number of cells contained in the support of the phonetic density. Such questions are answered by the following description of the invention.

### Dependencies for the Uniform Distribution

Assumption of uniform distribution is restrictive. However, it gives important initial insight into the problem, and thus is briefly presented here. Assume, that the probability density p(x) is of bounded support. Next assume, that a space partition is given for which holds: ∫_{R}_{ᵢ}p(x)dx=q, for all Rᵢ, such that Rᵢ∩S≠0/ where S={x:p(x)>0} is the mentioned support of the pdf p(x).

Next, let X={x₁ . . . x_{M}} be a random sample, whose elements are quantized, that is each sample is attached a natural number in the range 1, . . . , I. It could be seen, that such obtained indices of cells are governed by a multinomial distribution with K classes and K is less or equal I. It should be pointed out, that the number of cells K, which intersect with the support is unknown and our goal is to estimate it.

Let V will be a set of indices obtained by quantization of X. We can show, that conditional probability of the sample given the hypothetical Kₕ is equal:

$$P ( V \vert {K}_{h} ) = ( \begin{matrix}{K}_{h} \\ Z\end{matrix} ) ( \begin{matrix}M \\ {S}_{1} {S}_{2} … {S}_{Z}\end{matrix} ) \frac{1}{{K}_{h}^{M}} , \qquad ( 10 )$$

where Z is the number of distinct indices of bins included in V, Sᵢ is the number of repetitions of the bin with the index i, and M is the observation length. It could be seen that the maximum likelihood estimate for the hypothetical number of bins intersecting with the pdf under investigation, does not depend on the middle term, which includes the multinomial coefficient. Thus the estimate can be obtained by:

$$\hat{{K}_{h}} = {argmax}_{{K}_{h}} [ ( \begin{matrix}{K}_{h} \\ Z\end{matrix} ) {K}_{h}^{- M} ] . \qquad ( 11 )$$

The likelihood (10) is equal zero for K_{b} less than Z. We can separate out the following three modi of this likelihood function:
1) The likelihood function is monotonically increasing in [Z ¥)
2) The likelihood function is monotonically decreasing in [Z ¥)
3) There is a single maximum in the range [Z ¥)

It can be shown that the following conditions hold for each of the above listed modi:

The condition for 1) is:

Z=M. (12)

The condition for 2) is:

$$M > {log}_{( \frac{Z + 1}{Z} )} ( Z + 1 ) . \qquad ( 13 )$$

If M fulfills this condition then \hat{K}ₕ is equal Z. One can prove the following, interesting from the theory viewpoint, property. This property establishes the link with known in the statistical literature problem of coupon collector [11]:

$${lim}_{K -> ∞} ( \frac{K \times H ( K )}{{log}_{( \frac{K + 1}{K} )} ( K )} ) = 1. \qquad ( 14 )$$

In the above expression H(K) is the harmonic number equal, by definition,

$$H ( K ) = {\sum }_{i - 1}^{K} \frac{1}{i} .$$

The expression in the numerator is the mean number of trials needed to learn all bins intersecting with the support, while the unknown number of such bins is K.

The condition for 3) is:

$$v ln \frac{v}{v - 1} = u , \qquad ( 15 )$$

where

$$v = \frac{{\hat{K}}_{h}}{Z} and u = \frac{M}{Z} .$$

The proofs for the above three conditions follow.

The main vehicle of the proofs is the following expression valid for the harmonic numbers [12]:

$${\sum }_{k = 1}^{K} \frac{1}{k} = C + ln K + \frac{1}{2 K} - {\sum }_{k = 2}^{∞} \frac{{A}_{k}}{K ( K + 1 ) … ( K + k - 1 )} , \qquad ( 16 )$$

where C is the Euler-Mascheroni constant. It can be seen that asymptotically, as K approaches infinity, the terms after the logarithmic term vanish to zero. This leads to the following property:

$${lim}_{K -> ∞} ( {\sum }_{k = 1}^{K} \frac{1}{k} - ln ( K ) ) = C . \qquad ( 17 )$$

The proof for the condition 1) starts with taking logarithm of the considered expression (eq. (11)):

$$ln [ p ( V \vert {K}_{h} ) ] = {\sum }_{i - 1}^{{K}_{h}} ln ( i ) - {\sum }_{i - 1}^{Z} ln ( i ) - {\sum }_{j - 1}^{{K}_{h} - Z} ln ( i ) - M ln {K}_{h} . \qquad ( 18 )$$

Suppose now that i a continuous variable, which setting follows from allowing that variable to take on non-integer values. It can be seen that the middle sum does not depend on Kₕ so derivative w.r.t. that variable reads:

$$\frac{d}{d {K}_{h}} ln [ p ( V \vert {K}_{h} ) ] = {\sum }_{i - 1}^{{K}_{h}} \frac{1}{i} - {\sum }_{j - 1}^{{K}_{h} - Z} \frac{1}{i} - \frac{M}{{K}_{h}} = C + ln {K}_{h} - C - ln ( {K}_{h} - Z ) - \frac{M}{{K}_{h}} . \qquad ( 19 )$$

The last expression allows us to state the condition 3) which is either:

$$\begin{matrix}ln ( \frac{1}{1 - υ} ) , \\ with υ = \frac{Z}{{K}_{h}} and u = \frac{M}{{K}_{h}} , or & ( 20 ) \\ υln \frac{υ}{υ - 1} = u , & ( 21 )\end{matrix}$$

with

$$υ = \frac{{K}_{h}}{Z} and u = \frac{M}{Z} .$$

The loaner equation let us conclude that the sample length needed to learn a given percent of the bins intersecting with the support is a multiple of K.

Setting Z=M we see that, indeed, this (Z=M) is the sufficient and necessary condition for optimal Kₕ approaching infinity, thus proving the condition 1). This is due to the following identity:

$${lim}_{{K}_{h} -> ∞} \frac{{K}_{h}}{M} ln ( \frac{1}{1 - \frac{M}{{K}_{h}}} ) = 1 \qquad ( 22 )$$

It remains to prove the condition 2). In this case the maximum of the likelihood should be attained at Kₕ=Z. Thus we have a following inequality:

ln [p(V|Z)]>ln [p(V|Z+1)] (23)

which implies

ln(Z+1)−M ln(Z+1)<−M ln(Z) (24)

and, after some algebra, we attain at the condition 2):

$$M > {log}_{( \frac{Z + 1}{Z} )} ( Z + 1 ) \qquad ( 25 )$$

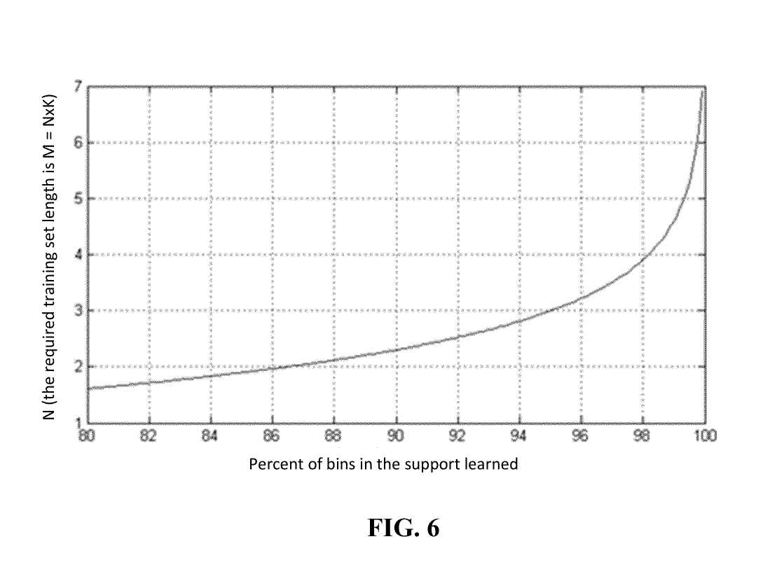

In FIG. 6, we illustrate the dependence of the data amount M needed to learn a given percent of bins in the support.

### Dependencies for the Non-Uniform Distribution

Next step will be derivation of the conditions analogous to the introduced in the previous Section, which are distribution free (we relax the assumption of bins of equal probabilities). To achieve the desired effect we introduce the probabilities of bins p=[p₁, . . . , p_{K}_{ₕ}].

Since we do not impose a constraint on the probabilities of bins the considered probability function is now in the form:

$$p ( V \vert {K}_{h} , {p}_{1} , … {p}_{{K}_{h}} ) = \frac{M !}{{S}_{1} ! … {S}_{Z} !} {\sum }_{\{ k : combinations of Z objects out of {K}_{h} objects \}} {\prod }_{i = 1}^{Z} {p}_{{k}_{i}}^{{S}_{i}} , \qquad ( 26 )$$

Where k={k₁, . . . , k_{Z}}. We integrate the above function over a unit simplex D:

$$D = \{ p : {\sum }_{i = 1}^{{K}_{h}} {p}_{i} = 1 , p ∈ {R}_{+}^{{K}_{h}} \} . \qquad ( 27 )$$

Note, that integrating out the probabilities in eq. (26) is not the only available strategy. Another method would be to maximize over the joint vector of Kₕ and p. As can be seen this is a polynomial optimization problem which is generally NP-hard. However some approximation algorithms exist, which run in polynomial time, see e.g. [13]. Another, a more viable one, approach would be to use the pmf estimator, with a proper handling of the back-off probabilities and use these estimated probabilities during computing a likelihood estimate of the joint vector according to (26). A good candidate algorithm for this approach could be the one given in [14]. In any case, as shown later in this document, the integrating-out strategy leads to neat mathematical results. Maximization-strategy, though forms an interesting alternative to the Natural Laws of Succession from [14], might be too computationally involved.

Let assume that all pmfs are equally likely. This corresponds to the assumption that we do not know the true pmf and attach to each possible p=[p₁, . . . , p_{K}_{ₕ}] an equal weight (we assume they are equally probable):

$$p ( V \vert {K}_{h} ) = \frac{1}{vol ( D )} {\int }_{D} p ( V \vert {K}_{h} , {p}_{1} , … {p}_{{K}_{h}} ) d p = … \frac{{K}_{h} !}{Z ! ( {K}_{h} - Z ) !} \frac{M !}{{\prod }_{i = 1}^{Z} {S}_{i} !} \frac{1}{vol ( D )} {\int }_{D} {p}_{1}^{{S}_{1}} \times … \times {p}_{Z}^{{S}_{Z}} d p , \qquad ( 28 )$$

where the equality (28) follows the fact, that the value of the integral does not depend on the choice and order of the probabilities in the monomial integrand. We present now the most important results without going into technical details. Some details of the derivations are contained in the Appendix.

The following expression for probability of Kₕ can be deduced starting from the equation (26):

$$p ( {K}_{h} \vert Z . M ) = \frac{{K}_{h} ! ( {K}_{h} - 1 ) !}{M ( {K}_{h} - Z ) !} \frac{Γ ( M - 1 )}{Γ ( M - Z - 1 ) Γ ( Z ) Γ ( Z + 1 )} \frac{1}{{\prod }_{i = M \vert \vert}^{M + {K}_{h} - 1} i} . \qquad ( 29 )$$

Similarly to the previously studied case of equal probabilities of bins we can separate the following three modi:
1. Function is increasing for Kₕ≧Z if and only if M=Z.
2. Function is decreasing for Kₕ≧Z if and only if M>Z².
3. Function has a single maximum at Kₕ for Kₕ≧Z if and only if

$$s = \frac{u}{u + 1}$$

$$where$$

$$s = \frac{Z}{{K}_{h}}$$

$$and$$

$$u = \frac{M}{{K}_{h}} .$$

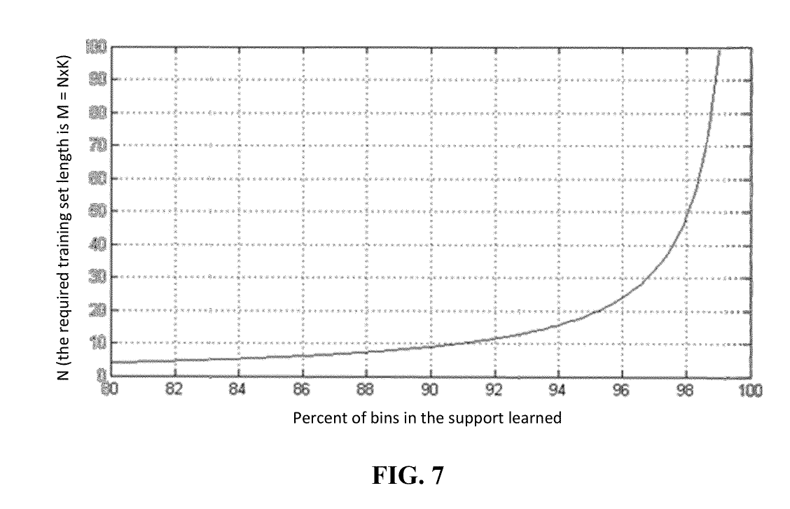

The FIG. 7 shows how the data amount requirements change according to selected percentage of “saturation” of the support. By saturation we mean the percentage of the total number of bins having at least one training sample in it.

### Choosing the Sample Length Sufficient to ‘Saturate’ the Bayes Risk

In choosing quantizer complexity the idea is to balance the accuracy (complexity of the model) and the generalization ability of the model. The generalization ability is measured by the ratio of M and Z, which we call the generalization coefficient in the remaining part of the patent. The larger the ratio is the better the model will generalize, what means it will work better for the samples outside the training set. However, as illustrated in the FIG. 5, the better generalizing model is the larger the cells are and the more ambiguities between classes arise. The ambiguity can be measured using the quantity known as the Bayes risk. It can be derived that for a pair of classes, A and B, the optimal Bayesian classifier [15] returns incorrectly the class label B while the observable comes from the class A actually, with the probability equal to the Bayes risk. Thus, formally speaking, the Bayes risk is equal:
for a probability density function:

$${C}_{AB} = {\int }_{\{ x : p ( x \vert A ) < p ( x \vert B ) \}} p ( x \vert A ) d x , \qquad ( 30 )$$

for a probability mass function:

$${C}_{AB} = {\sum }_{\{ o : P ( o \vert A ) < P ( o \vert B ) \}} P ( o \vert A ) . \qquad ( 31 )$$

In the Section 0 devoted to computations of the sample needed to estimate the support (entitled “Dependencies for the non-uniform distribution”) we saw that the sample needed to learn as much as 99% of the cells in the support is on the order of 100×K. The question is if we actually need such a good generalization—coming inevitably at the price of lower accuracy. It seems that much of the cells learned with the generalization coefficient set to that number is of negligible low probability. The intuition is that we can discard such cells and increase the accuracy of the model sacrificing the generalization. The discarding of the cells does not increase significantly the Bayes risk, since that cells are of such a low probability. As derived using Monte-Carlo experiments it suffices to take the generalization coefficient equal ˜8 to ‘saturate’ the Bayes risk, what means that increasing the sample length beyond 8×K, results in no further improvement of the classifier. This is a result of learning most of the ‘typical’ cells for the classes and discarding the low probability cells, which do not add to the Bayes risk significantly.

### Distribution of the Number of Codevectors in a Resolution Constrained Product Quantizers

An element of the proposed invention is a method to distribute the codevectors of the resolution constrained, cf. [16], product vector quantizer between the parts of the product. The so called product codebook is given by C=C₁×C₂ where the sum of the dimensions of the codevectors of C₁ and C₂ add up to give the dimension of the codevectors of C. The codevectors of the product codebook C are given in terms of the codevectors of C₁ and C₂ as:

$${y}_{( i - 1 ) \cdot {I}_{2} + j} = [ \begin{matrix}{y}_{i}^{( 1 )} \\ {y}_{j}^{( 2 )}\end{matrix} ] i ∈ \{ 1 , … , {I}_{1} \} , j ∈ \{ 1 , … , {I}_{2} \} , \qquad ( 32 )$$

where yᵢεC, yᵢ⁽¹⁾εC₁, yᵢ⁽²⁾εC₂ and I=I₁I₂, I₁=|C₁|, I₂=|C₂|.

In light of the above definition we propose the following procedure for choosing optimally the I₁ and I₂ to minimize total distortion. We start the derivation with recalling known from the high rate quantization theory results [16]. The distortion, assuming the so called Gersho's conjecture, introduced by a high rate, resolution constrained quantizer is equal:

$$E [ {‖ x - Q ( x ) ‖}_{2} ] = {\int }_{{Ω}_{x}} p ( x ) {g ( x )}^{- \frac{2}{k}} d x , \qquad ( 33 )$$

where g(x) is the density of the codevectors. The density of the codevectors is related to the number of such vectors by the following integral:

$${\int }_{{Ω}_{x}}^{ } g ( x ) d x = I . \qquad ( 34 )$$

According to the high rate quantization theory the optimal reproduction vectors density reads, in terms of the source distribution:

$$g ( x ) = I \frac{ {p ( x )}^{\frac{k}{k + 2}}}{{\int }_{{Ω}_{x}} {p ( x )}^{\frac{k}{k + 2}} d x} , \qquad ( 35 )$$

where k is the dimension of the source vectors.

Let define the marginal pdfs as:

$$\begin{matrix}p ( {x}^{( 1 )} ) = {\int }_{{Ω}_{2}} p ( x ) d {x}^{( 2 )} , & ( 36 ) \\ p ( {x}^{( 2 )} ) = {\int }_{{Ω}_{1}} p ( x ) d {x}^{( 1 )} , & ( 37 )\end{matrix}$$

where x lives in the product space Ω=Ω₁×Ω₂ and x⁽¹⁾ is the projection of the x onto the first subspace Ω₁, and x⁽²⁾ is the projection of the x onto the second subspace Ω₂. The quantizers are embedded in the corresponding subspaces, thus we can write C₁⊂Ω₁ and C₂⊂Ω₂.

Applying the high rate quantization theory results to the problem of distributing available I codevectors between the quantizers C₁ and C₂ we obtain the following Lagrange equation for the distortion induced by the product quantizer:

$$η = {I}_{1}^{- \frac{2}{{k}_{1}}} {P}_{1} + {I}_{2}^{- \frac{2}{{k}_{2}}} {P}_{2} + λ ( {I}_{1} {I}_{2} - I ) \qquad ( 38 )$$

where

$${P}_{1} = {( {\int }_{{Ω}_{1}} {p ( {x}^{( 1 )} )}^{\frac{{k}_{1}}{{k}_{1} + 2}} d {x}^{( 1 )} )}^{\frac{{k}_{1} + 2}{{k}_{1}}} , \\ {P}_{2} = {( {\int }_{{Ω}_{2}} {p ( {x}^{( 2 )} )}^{\frac{{k}_{2}}{{k}_{2} + 2}} d {x}^{( 2 )} )}^{\frac{{k}_{2} + 2}{{k}_{2}}} ,$$

and λ is the Lagrange multiplier. Minimization of the Lagrange [17] equation w.r.t. I₁ and I₂ and λ gives the desired solution (this computation can be done with ease using any computer algebra system, thus we do not provide it here)

### Procedure for Adjusting Complexity

Given above results the quantizer resolution selection proceeds as follows. Let the complexity/resolution/number of codevectors/volume of the discrete model be denoted as Π:

given: M, the training set and the assumed generalization coefficient N

### set Πₘₐₓ so as Z=M

### set Πₘᵢₙ so as Z=1

let H be the number of resulting subphonetic units, typically there are three subphonetic units per triphone set Mⱼ=M and Zⱼ=1, jε{1, . . . , H}.

$$while {min}_{j ∈ \{ 1 , … , H \}} ( {M}_{j} / {Z}_{j} ) \neq N$$

$$Π = \frac{1}{2} ( {Π}_{min} + {Π}_{max} ) \\$$

train a quantizer using e.g. GLA with I=Π codevectors (Π represents the number of codevectors in case of a trained quantizer), it could be possibly a product quantizer with number of codevectors I distributed among the part quantizers using the recipe from the section entitled “Distribution of the number of codevectors in a resolution constrained product quantizers;” or, set the volume of a cell in a lattice quantizer to be half a way between maximal complexity (minimal volume) and minimal complexity (maximal volume) lattice quantizer
find segmentation into subphonetic units—this step could be accomplished using e.g. Viterbi training
obtain Mⱼ and Zⱼ for each subphonetic unit, jε{1, . . . , H}

| $if {min}_{j ∈ \{ 1 , … , H \}} ( {M}_{j} \text{/} {Z}_{j} ) < N$ | |
|---|---|
| | set Πₘₐₓ = Π (or the volume of the cell of the lattice quantizer re- |
| | spectively) |
| else | |
| | set Πₘᵢₙ = Π (or the volume of the cell of the lattice quantizer re- |
| | spectively) |

end

end

return optimal complexity H and the optimal
quantizer

Method 1. Method for Finding an Optimal Quantizer

The parameter N in this algorithm is the generalization coefficient introduced in Section entitled “Choosing the sample length sufficient to ‘saturate’ the Bayes risk.” The above algorithm should be performed for each stream of the features vectors, that is for the basic MFCC's the delta MFCC's and the delta-delta MFCC's, separately (cf. the Section entitled “Computation and normalization of features”).

Since the generalization coefficient may vary across triphone clusters, we take as the generalization coefficient the smallest one taken over all triphone clusters. To compute the generalization coefficient one need to go through the whole segmentation/training procedure. The segmentation/training procedure can be, e.g., the Viterbi training, see [2], page 142. The algorithm results in optimal complexity quantizer given the training set. The returned optimal quantizer is a basis for forming the acoustic model in a straightforward manner, well known for those skilled in the art.

### Preferred Embodiment of the Invention

The procedure for adjusting discrete model complexity can be executed during a training phase of a speech recognition system. Necessary technical devices which allow for execution of the invented method are: any suitable computer with CPU/multiple CPUs (Central Processing Unit) with appropriate amount of RAM (Random Access Memory) and I/O (Input/Output) modules. For example it could be a desktop computer with a quad core Intel i7 processor with 6 GB of RAM, hard disk with 320 GB capacity, a keyboard, a mouse and a computer display. The procedure also can be parallelized for execution on a single server or a cluster of servers as well. It could be a server with two Xeon 6 core processors, with 24 GB RAM and 1TB hard disk. The latter configuration might be necessary if the training set grows especially large.

The procedure for adjusting discrete model complexity has been carried out for a relatively small training set comprising 100 hours of speech data from around 100 different speakers consists of the following steps:
Preparation of the training set as described in the Section entitled “Preliminary processing of the speech database.” The preparation of the speech database encompasses recording of acoustic waveforms using microphones, typically headsets or other, preferably electret or dynamic microphones. Signals from the microphones are digitized with 22050 Hz sampling rate and 16 bit per sample and stored in the mass memory. Typically the signals are resampled to 16000 Hz or 8000 Hz depending on speech recognition application. The speech signals are accompanied with orthographic transcriptions stored as text files with e.g. UTF-8 encoding. In our example we used recordings of numerals sequences.
Using technical computer devices described above the invented method is executed. The method is provided in Section entitled “Procedure for adjusting complexity.” The generalization coefficient N has been set to eight in our experiments.
Training of the acoustic model using, e.g., Baum-Welch algorithm, see e.g. [18].

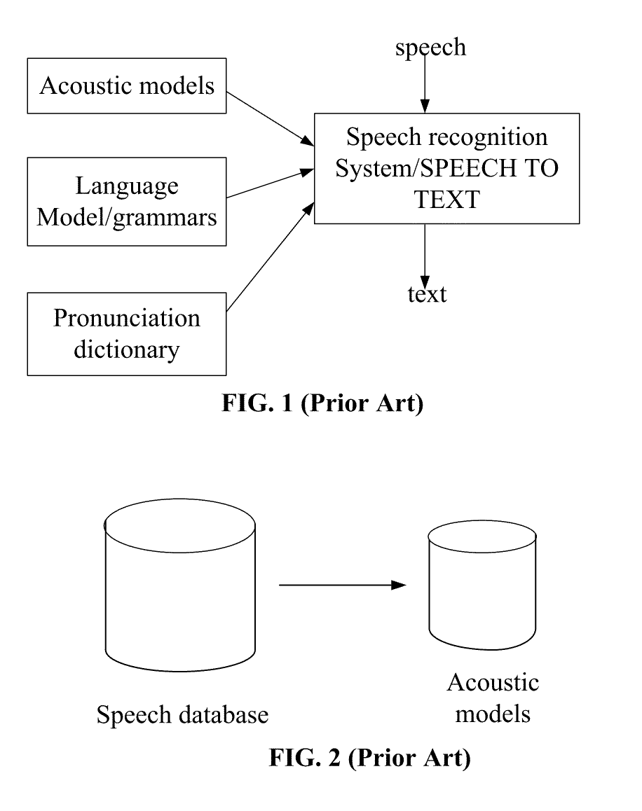

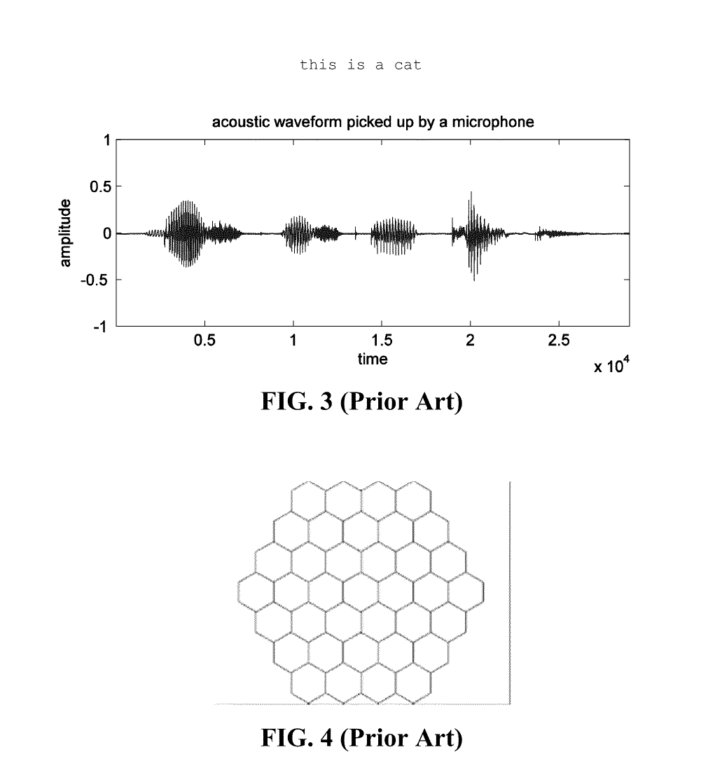

After these steps the acoustic model is ready for use in a speech recognition system, as shown in FIG. 1.

ASR system obtained using proposed invention is fast due to obtaining probability of a feature vector in a unit time. The operation of computing probability of a feature vector is a simple table lookup. Simultaneously the system is more robust to speakers outside the training set than while using classical approach of creating acoustic model. Such acoustic model optimized using proposed invention can be stored in memory of any device such as, for example, a mobile device, a laptop or a desktop device. The memory need not have very low access time, it could be even a slow flash memory. Given appropriately large training set collected from a large number of speakers set the system obtained using proposed invention is truly speaker independent, and does not require adaptation. This is due to the introduced generalization coefficient and the introduced procedure for adjusting complexity of the discrete model. Additionally, we observe an improvement in WER (Word Error Rate) as compared to the classical system with the number of codevectors set arbitrarily without optimization.

### Other Application Areas

Proposed method of adjusting complexity can be used virtually always if a fast and accurate classifiers are needed. Examples include, but are not limited to:
recognition, verification or authorization of speakers based on their voices,
authorization based on a photography of a face,
authorization based on fingerprints,
recognition of digitized graphical signs such letters, musical scores etc.

Introduced dependencies allow also for estimation of the data amounts requirements needed to achieve assumed WER (Word Error Rate) in a speech recognition system or other classifiers. The method leading to such operation is following, let N be equal eight:
We gather initial set of training data.
We assume a complexity PI1 and obtain acoustic model using data set length M1 which gives the generalization coefficient N.
We assume a larger complexity PI2 and obtain acoustic model using data set length M2, which gives the generalization coefficient N.
We measure the WER for the systems created above and derive an extrapolation of WER for growing complexity. After obtaining complexity which leads to the satisfactory WER we compute, using introduced in this description dependencies, what M is needed to achieve such complexity at maintained generalization coefficient N.

### APPENDIX

It can be shown using the Brion's formulae [19], that integral in eq. (28) evaluates to:

$$\frac{1}{vol ( D )} {\int }_{D} {p}_{1}^{{S}_{1}} \times … \times {p}_{Z}^{{S}_{Z}} d p = ( K - 1 ) ! \frac{{\prod }_{i = 1}^{Z} {S}_{i} !}{( M + K - 1 ) !} . \qquad ( 1 )$$

In light of the above expression we get:

$$p ( V \vert K ) = \frac{K ! ( K - 1 ) !}{Z ! ( K - Z ) !} \frac{1}{{{\prod }_{i = M + 1}}^{M + K - 1} i} . \qquad ( 2 )$$

and next:

$$p ( Z \vert K ) = \frac{( M - 1 ) !}{( Z - 1 ) ! ( M - Z ) !} \frac{K ! ( K - 1 ) !}{Z ! ( K - Z ) !} \frac{1}{{{\prod }_{i = M + 1}}^{M + K - 1} i} \qquad ( 3 )$$

To get the probability of the hypothetical number of quantizer bins intersecting with the support with given sample length a M and number of different bins indexes in the training set Z we apply a following derivation:

$$\begin{matrix}p ( K \vert Z , M ) = \frac{p ( Z \vert K , M ) \times p ( K )}{p ( Z \vert M )} \\ = \frac{p ( Z \vert K , M ) \times C}{{\sum }_{K = Z}^{∞} p ( Z \vert K , M ) \times C} \\ = \frac{p ( Z \vert K , M )}{{\sum }_{K = Z}^{∞} p ( Z \vert K , M )} ,\end{matrix} \qquad ( 4 )$$

where C is some constant (not to be confused with the Euler-Mascheroni constant used earlier in this document). By evaluating the sum in the denominator:

$${\sum }_{K = Z}^{∞} p ( Z \vert K , M ) = \frac{( M - 1 ) !}{( Z - 1 ) ! ( M - Z ) ! Z !} {\sum }_{K = Z}^{∞} ( \frac{K ! ( K - 1 ) !}{( K - Z ) !} \frac{1}{{{\prod }_{i = M + 1}}^{M + K - 1} i} ) , \qquad ( 5 )$$

we get:

$${\sum }_{K = Z}^{∞} p ( Z \vert K , M ) = \frac{M ( M - 1 ) !}{( Z - 1 ) ! ( M - Z ) ! Z !} \frac{Γ ( M - Z - 1 ) Γ ( Z ) Γ ( Z + 1 )}{Γ ( M - 1 )} . \qquad ( 6 )$$

Finally the probability of the hypothetical number of cells in the support is given by the following expression:

$$p ( K \vert Z , M ) = \frac{K ! ( K - 1 ) !}{M ( K - Z ) !} \frac{Γ ( M - 1 )}{Γ ( M - Z - 1 ) Γ ( Z ) Γ ( Z + 1 )} \frac{1}{{{\prod }_{i = M + 1}}^{M + K - 1} i} . \qquad ( 7 )$$

### REFERENCES

1. Huang, X., A. Acero, and H.-W. Hon, Spoken language processing, a guide to theory, algorithms, and system development. 2001: Prentice Hall.
2. Young, S., G. Evermann, and M. Gales, The HTK Book. 2009: Cambridge University Engineering Department.
3. Bisani, M. and H. Ney, Joint-Sequence Models for Grapheme-to-Phoneme Conversion. Speech Communication, 2008. 50(5): p. 434-451.
4. Weisstein, E. W. Cholesky Decomposition. 2012 [cited 2012 Jan. 19]; Available from: http://mathworld.wolfram.com/CholeskyDecomposition.html.
5. Gray, R. M., Vector Quantization. IEEE ASSP Magazine, 1984. 1: p. 4-29.
6. Conway, J. H., N. J. Sloane, and E. Bannai, Sphere packings, lattices, and groups. 1999, Berlin: Springer.
7. Equitz, W. H., A New Vector Quantization Clustering Algorithm. IEEE Transactions on Acoustics, Speech, and Signal Processing, 1989. 37: p. 1568-1575.
8. Sloane, N. J. A., Tables of Sphere Packings and Spherical Codes. IEEE Transactions on Information Theory, 1981. 27(3): p. 327-338.
9. Mei-Yuh Hwang, X. H., Fileno A. Alleva, Predicting Unseen Triphones with Senones. IEEE Transactions on Speech and Audio Processing, 1996. Vol. 4(No. 6): p. pp. 412-418.
10. Yves Normandin, R. C., Renato De Mori, High-Performance Connected Digit Recognition Using Maximum Mutual Information Estimation. IEEE Transactions on Speech and Audio Processing, 1994. Vol. 2(No. 2): p. 299-311.
11. Feller, W., An introduction to probability theory and its applications. 1957.
12. Gradshtein, S., et al., Table of integrals, series and products. 2007, London: Academic Press.
13. Klerk, E., M. Laurent, and P. Parrilo, A PTAS for the Minimization of Polynomials of Fixed Degree over the Simplex. Theoretical Computer Science, 2006. 361(2).
14. Ristad, E. S., A Natural Law of Succession. 1995, Princeton.
15. Devroye, L., L. Gyorfi, and G. Lugosi, A probabilistic theory of pattern recognition. 1996: Springer.
16. Kleijn, W. B., A basis for source coding. 2006, Royal Institute of Technology: Stockholm.
17. Gluss, D. and E. W. Weisstein. Lagrange Multiplier. 2012 [cited 2012 Jan. 22]; Available from: http://mathworld.wolfram.com/LagrangeMultiplier.html
18. Rabiner, L. and B. H. Juang, Fundamentals of speech recognition. 1993: Prentice Hall.
19. Baldoni, V., et al., How to Integrate a Polynomial over a Simplex arXiv:0809:2083.

1. A method for adjusting a discrete acoustic model complexity in an automatic speech recognition system comprising a discrete acoustic model and a pronunciation dictionary, said method comprising the steps of:
providing a speech database, comprising a plurality of pairs, each pair comprising a speech recording called a waveform and an orthographic transcription of the waveform; constructing the discrete acoustic model by converting the orthographic transcription into a phonetic transcription; parameterizing the speech database by transforming the waveforms into a sequence of feature vectors and normalizing the sequences of the feature vectors, followed by the complexity (PI) adjustment procedure characterized in that, with a given generalization coefficient N:
a0. initialization of the PIₘₐₓ such that each quantizer cell contains single training sample and PIₘᵢₙ such that one quantizer cell contains all training samples;
a1. a set of features vectors is taken from the speech database and a quantizer is trained, having complexity of PI=½*(PIₘₐₓ+PIₘᵢₙ);
a2. the training set is quantized with the quantizer obtained in the a1 step;
a3. the training set is segmented into triphones and subphonetic units with the acoustic models implied by the quantizer trained in the a1 step;
a4. if minimum, taken over all triphones and subphonetic units, of M/Z, where M is the number of training samples in a given triphone or subphonetic unit and Z is the number of distinct acoustic symbols belonging to that triphone or subphonetic unit, is less than the assumed generalization coefficient N, the value of PI is taken as the maximal complexity PIₘₐₓ of the discrete acoustic model, and otherwise as the minimal complexity PIₘᵢₙ; and
a5. repeating steps a1-a4 until minimum, taken over all triphones and subphonetic units, of M/Z, is equal to assumed generalization coefficient N.

2. The method according to claim 1, wherein the generalization coefficient N of the quantizer is larger than 5.

3. The method according to claim 1, wherein the quantizer in the step a1 is trained using the generalized Lloyd algorithm or the Equitz method.

4. The method according to claim 1, wherein the complexity PI of the quantizer of the discrete acoustic model is defined as a number of codevectors in the trained quantizer.

5. The method according to claim 1, wherein the quantizer in the step a1 is a product quantizer with number of codevectors I distributed among part quantizers.

6. The method according to claim 1, wherein the quantizer in the step a1 is a lattice quantizer.

7. The method according to claim 6, wherein the complexity PI of the quantizer of the discrete acoustic model is defined as the volume of the lattice quantizer cell taken with a minus sign.

8. The method according to claim 1, wherein the step a3 is carried out using the Viterbi training.

9. The method according to claim 1, wherein the step a3 is carried out for clustered triphones or tied triphones.

10. The method according to claim 1, wherein said automatic speech recognition system further comprises a language model or a grammar model.

11. The method according to claim 2, wherein the generalization coefficient N of the quantizer is larger 10.

12. The method according to claim 2, wherein the generalization coefficient N of the quantizer is larger than 15.
